(19) United States
(12) Patent Application Publication
(10) Pub. No.: US 2018/0286271 A1
(43) Pub. Date: Oct. 4, 2018

(54) CONFIGURING AND OPERATING COMPUTERIZED AGENTS TO COMMUNICATE IN A NETWORK

(71) Applicant: Yale University, New Haven, CT (US)

(72) Inventors: Nicholas A. Christakis, Norwich, VT (US); Hirokazu Shirado, New Haven, CT (US)

(73) Assignee: Yale University, New Haven, CT (US)

(21) Appl. No.: 15/941,871

(22) Filed: Mar. 30, 2018

Related U.S. Application Data
(60) Provisional application No. 62/478,727, filed on Mar. 30, 2017.

(51) Int. Cl. G09B 17/00; H04L 12/58; G06N 99/00

(52) U.S. Cl. CPC G09B 17/00; H04L 51/32; G06N 99/005; H04L 51/02

(57) ABSTRACT

Described herein are embodiments of a method of influencing humans who interact in a network towards accomplishing a goal. The method may include configuring at least one computerized agent to interact with the humans in the network. Configuring the at least one computerized agent may include selecting a value associated with at least one parameter with which to configure the at least one computerized agent, wherein the value associated with the at least one parameter comprises a probability that affects how the at least one computerized agent acts at a time to influence the humans towards accomplishing the goal, wherein the probability affects how the at least one computerized agent acts by impacting whether the at least one agent at the time directly assists with performance of the goal at the time or at the time indirectly assists with the performance of the goal at the time.

### RELATED APPLICATIONS

This Application claims priority under 35 U.S.C. § 119(e) to U.S. Patent Application Ser. No. 62/478,727, filed Mar. 30, 2017, and titled “CONFIGURING AND OPERATING COMPUTERIZED AGENTS TO COMMUNICATE IN A NETWORK,” the contents of which are incorporated herein in their entirety.

### BACKGROUND

Human users may arrange themselves in a social network and communicate in the social network regarding a variety of topics. In some cases, the humans may communicate in the social network for the purpose of exchanging information that is perceived to be important, such as related to current events, or to assist one another in achieving some objective, such as an individual health objective like losing weight or quitting smoking.

### SUMMARY

In one embodiment, there is provided a method of influencing humans who communicate in a social network toward accomplishing a goal. The method comprises receiving information indicating an arrangement of the humans in the social network, the arrangement of the humans indicating a number of the humans and an interconnectedness of the humans in the social network. The method further comprises configuring a plurality of computerized agents to communicate with the humans in the social network, wherein configuring the plurality of computerized agents comprises selecting a number of the plurality of computerized agents and an interconnectedness of each computerized agent of the plurality with at least some of the humans based at least in part on the arrangement of the humans in the social network. The method further comprises, with the plurality of computerized agents, impersonating a second group of humans communicating in the social network, wherein impersonating the second group of humans comprises communicating, via the social network, to the humans via the social network regarding the goal and in a manner to influence accomplishment of the goal.

In another embodiment, in the method of any one or more of the foregoing embodiments, communicating to the human via the social network comprises responding to messages communicated by the humans via the social network.

In a further embodiment, in the method of any one or more of the foregoing embodiments, configuring the plurality of computerized agents comprises configuring each computerized agent of the plurality to select, for a message to be communicate by the computerized agent, whether to communicate information of a first type or of a second type in accordance with a first probability, wherein information of the first type directly assists with accomplishing the goal and information of the second type does not directly assist with accomplishing the goal, and communicating via the social network to the humans comprises, for each communication, selecting whether to communicate information of the first type of information of the second type in accordance with the first probability.

In another embodiment, in the method of any one or more of the foregoing embodiments, configuring the plurality of computerized agents to select in accordance with a first probability comprises configuring all of the plurality of computerized agents with the same probability.

In a further embodiment, in the method of any one or more of the foregoing embodiments, configuring the plurality of computerized agents to select, in accordance with a first probability, whether to communicate information of the first type or of the second type comprises configuring the plurality of computerized agents to select whether to communicate correct information or incorrect information.

In another embodiment, in the method of any one or more of the foregoing embodiments, communicating via the social network to the humans comprises responding to a communication posted by a human in the social network, and selecting whether to communicate information of the first type or of the second type in accordance with the probability comprises, in response to the communication posted by the human, determining whether the communication posted by the human contains correct information and, in response to determining that the communication posted by the human contains correct information, selecting, in accordance with the first probability, whether to repeat the correct information via the social network.

In a further embodiment, the method of any one or more of the foregoing embodiments further comprises, in response to selecting not to repeat the correct information via the social network, communicating incorrect information via the social network.

In another embodiment, in the method of any one or more of the foregoing embodiments, configuring the plurality of computerized agents to select, in accordance with a first probability, whether to communicate information of the first type or of the second type comprises configuring the plurality of computerized agents to select whether to communicate encouraging information or discouraging information.

In a further embodiment, in the method of any one or more of the foregoing embodiments, communicating via the social network to the humans comprises responding to a communication posted by a human in the social network and selecting whether to communicate information of the first type or of the second type in accordance with the probability comprises, in response to the communication posted by the human, determining whether the communication posted by the human contains encouraging information and, in response to determining that the communication posted by the human contains correct information, selecting, in accordance with the first probability, whether to repeat the encouraging information via the social network.

In another embodiment, the method of any one or more of the foregoing embodiments further comprises, in response to selecting not to repeat the correct information via the social network, communicating discouraging information via the social network.

In a further embodiment, in the method of any one or more of the foregoing embodiments, configuring the plurality of computerized agents comprises configuring each computerized agent of the plurality to communicate in the social network, in response to communications of the humans in the social network, following a specified delay.

In another embodiment, in the method of any one or more of the foregoing embodiments, configuring the plurality of computerized agents to respond following a specified delay comprises configuring all of the plurality of computerized agents with the same delay.

In a further embodiment, the method of any one or more of the foregoing embodiments further comprises, evaluating communications of the humans in the social network over time to determine a progress toward the goal, and based on a result of the evaluating, re-configuring the plurality of computerized agents, and the reconfiguring comprises one or more re-configurations from a group of re-configurations comprising adjusting a number of computerized agents, adjusting an interconnectedness of one or more of the plurality of computerized agents with the humans, adjusting the first probability for one or more of the plurality of computerized agents, and adjusting the specified delay for one or more of the plurality of computerized agents.

In another embodiment, in the method of any one or more of the foregoing embodiments, selecting the number of the plurality of computerized agents and the interconnectedness of each computerized agent of the plurality with at least some of the humans based at least in part on the arrangement of the humans in the social network comprises selecting the number of the plurality of computerized agents and the interconnectedness to optimize a speed with which the goal is achieved.

In a further embodiment, in the method of any one or more of the foregoing embodiments, selecting the number of the plurality of computerized agents and the interconnectedness of each computerized agent of the plurality with at least some of the humans based at least in part on the arrangement of the humans in the social network comprises selecting the number of the plurality of computerized agents and the interconnectedness to optimize a degree to which the goal is achieved.

In another embodiment, in the method of any one or more of the foregoing embodiments, selecting the number of the plurality of computerized agents and the interconnectedness of each computerized agent of the plurality with at least some of the humans based at least in part on the arrangement of the humans in the social network comprises selecting the number and the interconnectedness of the plurality of computerized agents using a model trained to identify a number and interconnectedness of computerized agents based on a number and interconnectedness of humans.

In a further embodiment, there is provided a method of influencing humans who interact in a network towards accomplishing a goal. The method comprises configuring at least one computerized agent to interact with the humans in the network. Configuring the at least one computerized agent comprises selecting a value associated with at least one parameter with which to configure the at least one computerized agent. The value associated with the at least one parameter comprises a probability that affects how the at least one computerized agent acts at a time to influence the humans towards accomplishing the goal, and the probability affects how the at least one computerized agent acts by impacting whether the at least one agent at the time directly assists with performance of the goal at the time or at the time indirectly assists with the performance of the goal at the time. Configuring the at least one computerized agent further comprises configuring the at least one computerized agent with the selected value associated with the at least one parameter.

In another embodiment, there is provided a system comprising a computer-readable medium storing executable instructions and at least one processor programmed by the executable instructions to configure at least one computerized agent to interact with humans in a network. Configuring the at least one computerized agent comprises selecting a value associated with at least one parameter with which to configure the at least one computerized agent. The value associated with the at least one parameter comprises a probability that affects how the at least one computerized agent acts at a time to influence the humans towards accomplishing the goal, and the probability affects how the at least one computerized agent acts by impacting whether the at least one agent at the time directly assists with performance of the goal at the time or at the time indirectly assists with the performance of the goal at the time. Configuring the at least one computerized agent further comprises configuring the at least one computerized agent with the selected value associated with the at least one parameter.

In a further embodiment, there is provided a computerized agent configured to interact with humans in a network and influence the humans towards accomplishing a goal. The computerized agent comprising at least one processor and at least one computer-readable storage medium having encoded thereon executable instructions that, when executed by the at least one processor, cause the at least one processor to carry out a method. The method comprises influencing the humans toward accomplishing the goal, wherein influencing the humans comprises interacting with one or more of the humans and wherein interacting with the one or more humans comprises determining a manner in which to interact with the one or more humans, wherein determining a manner in which to interact at a time comprises selecting, based on a parameter, whether to directly assist at the time with performance of the goal or to indirectly assist at the time the performance of the goal.

In a further embodiment, there is provided at least one non-transitory computer-readable storage medium having encoded thereon executable instructions that, when executed by at least one processor, cause the at least one processor to carry out the method of any one or more of the foregoing embodiments.

In another embodiment, there is provided an apparatus comprising at least one processor and at least one storage medium having encoded thereon executable instructions that, when executed by the at least one processor, cause the at least one processor to carry out the method of any one or more of the foregoing embodiments.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a system with which some embodiments may operate;

FIG. 2 is a flowchart of a process that may be implemented in some embodiments to configure and operate agents to interact with humans in a network;

FIGS. 3A-3B are flowcharts of illustrative processes for selecting values for parameters with which agents are configured;

FIG. 4 depicts survival curves of sessions involving nine treatment combinations of noisiness and position of agents in a networked color coordination game, in accordance with some embodiments;

FIG. 5 shows an average accumulated time of unresolvable conflicts per link for each position of the players in the networked color coordination game, in accordance with some embodiments;

FIG. 6A depicts a network composed of social clusters, where ties are dense within and sparse between the clusters, in accordance with some embodiments;

FIG. 6B shows agents placed in the network to widen the bridge connecting the clusters, in accordance with some embodiments; and

FIG. 7 is a block diagram of a computing device with which some embodiments may operate.

### DETAILED DESCRIPTION

Described herein are techniques for configuring and operating computerized agents in a network of humans to influence the humans toward a goal, such as a goal set by the humans in the network for the humans to accomplish or a goal of another who would like the humans in the network to achieve the goal. Such a goal may include the humans individually or collectively acting in a manner that satisfies one or more parameters, such as communicating with one another in a certain way or working together in a certain way. The computerized agents may influence the humans by taking actions that are visible to humans in the network or that the humans in the network are or become aware of, including by communicating with one or more (including all) of the humans in the network at a time. The computerized agents may be configured to interact with one or more humans in the network in accordance with configuration parameters, which may include a number of computerized agents in the network and interconnections between the computerized agents and the humans. In some embodiments, the configuration parameters may adjust whether a computerized agent acts at a time in a way that directly influences the humans toward the goal or indirectly influences humans toward the goal, where such indirect influencing may include acting at the time in a way that influences the humans away from performance of the goal. Including such “noisy” actions that influence the humans away from performance of the goal may, in some scenarios, aid in influencing the humans toward the goal, such as causing the humans to work toward the goal or achieve the goal faster or more efficiently than if the computerized agents were only to directly influence the humans toward accomplishing the goal.

A group of humans may communicate with one another in a manner that may be modeled as a network (e.g., a social network), with the network indicating how the humans interact and exchange information. Such a network may exist for a variety of purposes, including social or commercial purposes, or for no purpose at all, such as in a case where the network may be a group of people that came together in an ad hoc manner and are not necessarily collaborating or cooperating with one another for any reason. Such a group of people may be people traveling together (e.g., drivers on a same road) or customers at a business at a time, or another group of people. Such a group of people may be people interacting in person or via online or other media. In addition, the network may be one that extends for a long period of time, like networks of friendships or work colleagues that may last for years, or may be a transient network, such as a group of humans that had no relationship to one another before coming together and may not have a relationship after coming together, such as one of the networks without a purpose discussed above. Such a transient network may last for a handful of hours or less than an hour, or even minutes in some cases.

In some cases, there may be an advantage to the humans in such networks taking collective or collaborate actions to achieve a goal. There may be a variety of goals, which may range based on the type of networks or the humans in the network. For example, for a group of coworkers, the coworkers may be collaborating to produce a product, and the goal may be fast and efficient generation of the product, or for a group of individuals, the individuals may be coordinating to visit a particular destination, and the goal may be meeting at the destination at a particular time. For an ad hoc network that is a group of drivers on the road, a goal may be driving together without a traffic jam or collision.

Human networks often may encounter difficulty in achieving favorable collective or collaborative action. Such difficulties may arise not only from conflicting interests among individuals, or between individuals and their group, but also as a consequence of the inability of individuals to effectively coordinate their actions globally. Even if all individuals in the network behave properly in their local interactions, this may not result in a favorable outcome for the whole community. For example, different workers might each labor to enhance their own productivity, but this might decrease the overall performance of the company with information conflict and overload, excess investments, and opportunity costs.

One approach used to understand how changes in a network might affect the behavior of individuals, and vice-versa, is simulation. Computer simulations typically work by observing some set of features of the network and building in other assumptions about human behavior in order to reach an understanding of how the confluence of various influences might affect human behavior. While simulations offer insight into online social dynamics, they cannot provide satisfying answers to questions of cause and effect (e.g., what particular behavior in the network caused a group of individuals to achieve a goal, or what behavior improved the likelihood of the goal to be achieved).

The inventors have recognized and appreciated that instead of simulating agents based upon observational studies, arranging computerized, autonomous agents that are capable of impersonating humans and communicating with other humans in a network can influence the humans toward achievement of a goal through their communications with the humans. For example, the computerized agents may communicate messages via the network to the humans (and, in some cases, to other computerized agents via the network) to influence the humans to perform some action or otherwise act or think in a certain way (e.g., possess some opinion or knowledge). Additionally or alternatively, such computerized agents may take one or more actions that may influence the humans to take actions in turn. For example, for an ad hoc network that is a group of humans driving together, a computerized agent may be a part of an autonomous vehicle (or a vehicle operating an autonomous mode of operation) and the computerized agent may take actions such as varying its speed, braking, changing lanes, or otherwise changing a manner of operating the vehicle. This may, in turn, trigger humans to change behaviors. Other networks may have similar actions that, when taken by the computerized agents, affect actions of the humans, with the form of those actions varying based on the networks.

The inventors have further recognized and appreciated that behavior of the computerized agents can be manipulated and experimentally varied, and the effects of this manipulation on the observed behavior of involved humans can be measured directly. For instance, certain parameters associated with the computerized agents and/or the network may be manipulated to improve the likelihood of the goal being achieved and/or the rate at which the goal is achieved. Examples of such parameters include, a number of agents in the network, a number of humans to which one or more agents are connected in the network, placement/location of agents in the network, a level of noisiness associated with the agents in the network, visibility of the agents to the humans in the network, whether the agents function (in part) to broker or make connections among humans in the network, a network topology of the network (i.e., network structure including arrangement of humans and agents), a group size, a fraction of the network that is composed of agents (i.e., agent fraction), whether the network is dynamic or static, whether social institutions (for example, policing, sanctions, or norms) are present in the network, and/or other parameters. For example, the inventors have recognized and appreciated that introducing computerized agents having a particular level of noisiness at certain locations within the network can assist the humans to achieve the goal for complex tasks at a much faster rate than networks involving only humans.

In some embodiments, the computerized agents may be configured, including based on such parameters, to communicate in the network so as to influence the humans toward achievement of a goal. The configuration may include configuring each agent or a group of the agents based on the goal and/or based on the humans, such as based on an arrangement of humans in the network.

In accordance with the configuration, the computerized agents may change a manner in which they communicate to the humans in the network, such as by changing a content of communications with the humans, and may also adjust whether or not the humans are aware that the computerized agents are nonhuman. In some embodiments, the network may be a social network in which the humans communicate by communicating to one another messages that may include content, which may include textual content and/or audiovisual content (with such audiovisual content including audio content and/or visual content). The computerized agents may impersonate humans by communicating messages (including textual and/or audiovisual content) to one or more humans in the network. The computerized agents may further impersonate humans by presenting information that humans typically present in the social network, such as by presenting profile information, presenting alleged personal historic or demographic information, and/or presenting information on multiple different topics (such as information unrelated to the goal). The presentation by the agents may include communicating such information in one or more messages via the network, to one or more humans and/or one or more other agents. In addition, the computerized agents may impersonate humans because the humans in the network may not be informed by the computerized agents, by an operator of the computerized agents, or by an operator of the network that the computerized agents are not human. In some embodiments, the computerized agents may impersonate humans because the network is not informed that the agents are not human, and/or because the network treats communications sent via the network by the agents in the same manner as it treats communications sent via the network by the humans.

The arrangement of the humans may include the number and/or interconnectedness of the humans, such as an indication of how each human is connected to one or more other humans in the network or a number of humans to which a human is connected, or a topology of the connections between humans in the network. Connections between humans in the network may be physical, logical/virtual, or otherwise, based on the nature of the network. For example, in a social network, two humans may “connect” with one another in the network (e.g., by identifying to the social network that they are “friends”, “connected”, etc.) to form an association between the humans in the network such that the humans may communicate to one another via the network or such that the network delivers communications broadcast or otherwise sent by one human to the other, associated human. The connection between humans may not exist as a physical connection, but instead may be data stored by the network identifying the connection. The topology of the connections of the human may indicate whether the humans are or tend to be connected in a tight mesh or fully connected mesh, a loose mesh, a tree, a star, a line, or other topology.

The computerized agents may be configured based on the information about the goal or the humans in a manner that affects how the agent(s) will communicate in the network once configured and/or alter the interconnectedness of the humans in the network. For example, the configuration may include configuring an arrangement of the agents in the network. Configuring the arrangement of the agents may include determining a number of the agents that will communicate in the network. Based on the number of agents that is determined, agents may be instantiated or de-instantiated. The arrangement may further include configuring an interconnectedness of each agent to other agents and/or to the humans of the network. The interconnectedness of an agent may indicate how the agent communicates to other agents or humans via the network, such as how the network will distribute communications sent by the agent to other agents or humans. For example, configuring the interconnectedness of an agent may include establishing a connection (e.g., as a “friend” or “connection” in a social network) between an agent and one or more humans users. Once the agent is connected to one or more humans and/or one or more agents, the network may communicate messages broadcast or otherwise sent by an agent to the human(s) and/or the agent(s) to which the agent is connected in the network. In embodiments in which configuration includes an interconnectedness of agents, each agent may be configured with the same interconnectedness or a different interconnectedness. In some embodiments, the configuration may include configuring the agents in a manner that influences an interconnectedness of the humans in the network by, for example, altering an existing interconnectedness of the humans by adding new connections between the humans, and/or modifying existing connections between the humans, or encourages such alterations, such as by encouraging humans to add or modify connections. For instance, the agent may be configured as a “broker” agent that facilitates an introduction between two or more humans, which may be intended to trigger, and which may trigger, the humans to create new connections in the network. For example, the agents may, based on evaluation of communications in and/or with a group of humans in which a first human in the group is not connected to a second human in the group, determine that it may be beneficial for influencing the humans toward the goal if the first and second humans were to be directly connected to each other in the network. For example, the agent may determine, from an analysis of a flow of information in the group or an exchange of communications in the group, that information may percolate faster or more efficiently if two humans in the group were directly connected or otherwise would directly communicate. As a result of that determination, the agent may facilitate an introduction between the first and second humans. The agent may facilitate such an introduction by communicating introductory messages to the first and second humans, where the messages are tailored to urge the first and second humans to connect with one another.

As a further example of configuration, in some embodiments the computerized agents may be configured with a delay that the agents will use in responding, via the network, to messages received by the agents via the network, including messages received via the network from a human to which the agent is connected and/or from an agent to which the agent is connected. For example, when the agent receives, via the network, a message that a human or another agent to which the agent is connected sent a message via the network, the agent may either respond to the message or not respond to the message. Responding to the message may include sending a new message via the network, either to the source of the message or to one or more other humans/agents. The new message may include the content of the message that was received via the network, such that the agent is relaying the message. The new message may additionally or alternatively include other content, which the agent selected for inclusion in the new message. In cases in which the agent is configured with a delay, the delay may be used by the agent in determining when to transmit the new message. For example, the agent may transmit any such responsive messages at a time that follows, by the length of the delay, receipt of a message via the network. As another example, the agent may transmit any such responsive messages at a time that is randomly selected (herein, randomly should be understood to include pseudo-randomly) to be a time between no delay or a minimum delay and a maximum length of time that matches the length of the delay with which the agent is configured. As a further example, the agent may transmit any such responsive messages at a time randomly selected to be a time between a minimum delay that matches the length of the delay with which the agent is configured and a maximum delay. The delay may be used in other ways to determine a timing for transmission of a message, as embodiments are not limited in this respect. In embodiments in which configuration includes configuring with such a delay, the agents may be configured with the same delay, or agents may be configured with varying delays.

As another example of configuration, in some embodiments the computerized agents may be configured to communicate messages that assist with performance of the goal by influencing the humans toward achievement of the goal, and to communicate messages that do not assist with performance of the goal by influencing humans away from achievement of the goal. For example, in some embodiments, each computerized agent may be configured with a probability to be used by the agent in selecting content of a message to be communicated at a time, such that content that assists with performance of the goal may be communicated at a time with the configured probability, and content that does not assist with performance of the goal or that may hinder performance of the goal with a complementary probability. As another example, each agent may be configured with a probability such that content that assists with performance of the goal may be communicated at a time with the configured probability, content that would hinder performance of the goal may be communicated with a second probability, content that would neither assist nor hinder performance may be communicated with third probability, and/or no message may be transmitted with a fourth probability. In some cases, the agent may be additionally configured with the second, third, and/or fourth probabilities. In embodiments in which configuration includes specification of such a probability or set of two or more probabilities, each agent may be configured with a same probability or set of probabilities, or the agents may be configured with varying probabilities.

In examples above, communications that may assist with achieving a goal were described without specific mention of examples of goals. It should be appreciated that embodiments are not limited to use with a particular goal or type of goal. Embodiments may operate in environments in which a goal is for the humans in the network or at least a percentage of humans in the network act in a certain way or think in a certain way, such as by understanding or believe in a particular idea or concept or possessing a particular opinion or knowledge. As a specific example, a goal may relate to individual health of the humans, such as that each human lose a certain amount of weight or reach a biological state (e.g., body-mass-index, percent body fat, etc.) that has been deemed healthy, or such that each human quit smoking. As another specific example, a goal may relate to understanding or belief of information among the humans, such as that each human have a correct understanding or a correct belief associated with a particular topic. As another example, the goal may relate to activities of the humans outside a social network, such as that each human engage in community service or charitable activities.

The agents, once configured, may communicate in the network to achieve performance of the goal, such as by communicating messages via the network to the humans such that, over a period of time, the goal is achieved. For example, if the goal relates to an individual health of the humans, the agents may communicate to the humans messages that encourage the humans toward achievement of the goal, such as messages that encourage the humans toward quitting smoking. The messages may include suitable content that may encourage a human to quit smoking, such as messages declaring that the agent had not used tobacco products for a period of time (the agent may be impersonating a human with a nicotine addiction) or messages describing the negative side effects of tobacco products. As discussed above, however, the agents may also communicate messages that discourage humans from quitting smoking or that may tend to hinder humans from quitting smoking. This may be, for example, a message with content indicating that an agent lapsed and had a cigarette, or indicating that the agent is no longer going to try to quit smoking, or complaining about how hard it is to quit smoking. Such messages may, individually, tend to hinder performance of the goal. The inventors have recognized and appreciated, however, that communicating to humans an appropriate mix of messages that assist with performance of the goal and messages that hinder performance of a goal may, overall, increase a likelihood that the humans will be influenced to act in a certain way and the goal may be achieved. Similarly, in the case that a goal includes humans correctly understanding or believing information related to a particular topic, both correct and erroneous information may be communicated by the agents.

Described below are examples of systems with which embodiments may operate and techniques that may be implemented in embodiments to configure and operate agents. It should be appreciated, however, that embodiments are not limited to operating in accordance with any of the embodiments below and that other embodiments are possible.

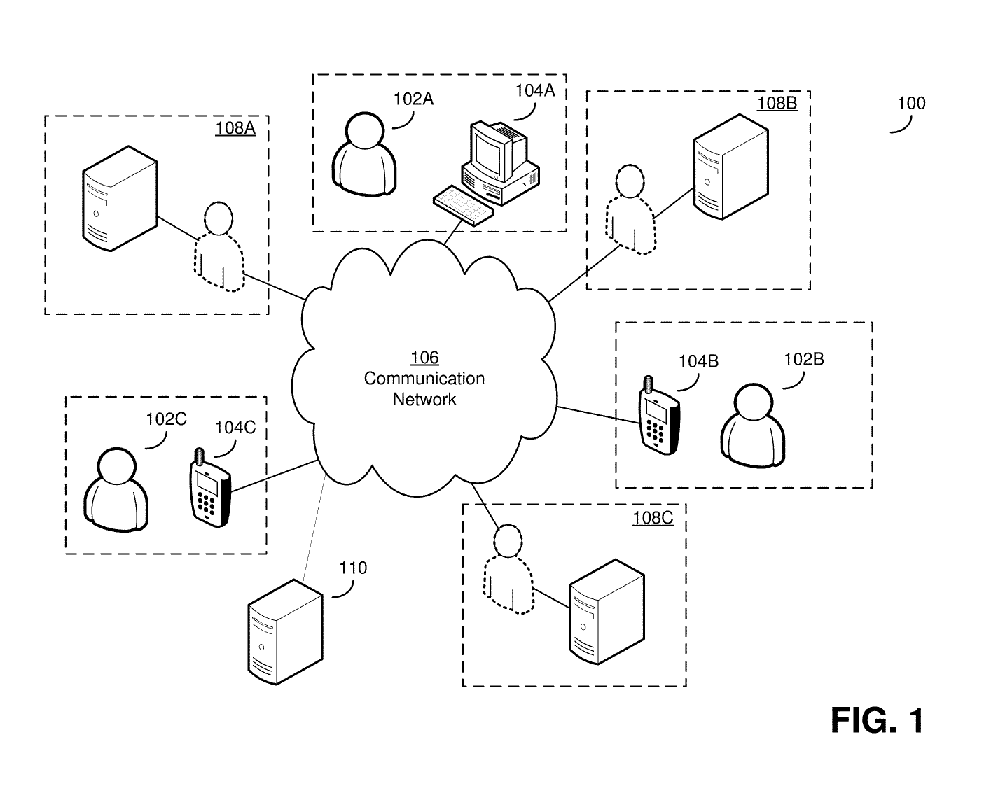

FIG. 1 illustrates an example of a computer system 100 in which some embodiments may operate. The system 100 of FIG. 1 includes multiple different humans 102A, 102B, 102C (collectively referred to herein as humans 102, or generically as human 102) that operate computing devices 104A, 104B, 104C (collectively referred to herein as devices 104, or generically as device 104) to communicate via a network 106. The computing devices 104 may be any suitable devices for transmitting and receiving electronic communications via a network (e.g., social network), including desktop and/or laptop personal computers, mobile devices (e.g., smart phones, tablet computers, etc.), or other devices. The network 106 may be a social network, and the humans 102 may each operate a device 104 to send and/or receive messages via the social network.

As is known, via a social network, the humans 102 may send messages that are broadcast to other humans or send messages that are targeted to one or more specific humans. The recipients of a message transmitted by a human 102 via the network 106 may be other users (e.g., other humans) of the network 106 to which the human 102 is connected in the network. The network 106 may maintain a data store identifying the other users to which a user is “connected” in the network, to identify recipients of messages. In the case of a broadcast message sent by a human 102, the network 106 may deliver the message (or at least make the message available to view) to all other users to which the human 102 is connected. In the case that a message is to be sent to one or more specified recipients, the network 106 may deliver the message (or at least make the message available to view) to the specified recipients or those specified recipients to which the human 102 is connected.

As discussed above, the humans 102 may be connected in the social network via any suitable topology. Accordingly, each humans 102 may be connected to one other human 102, multiple other humans 102, or all other humans 102.

The network 106 may include a network facility to operate the network (e.g., operate the social network) and maintain a data store of information about users of the network. The network facility may communicate messages between users, such as by identifying messages to be made available to (and/or delivered to) particular users and making the messages available to (and/or delivering the messages to) those users. The network facility may use information on connections between users to determine recipients. The network facility may also maintain a data store of information relating to users and use of the network 106, such as a data store of profile information about users and a data store of messages communicated by the users. The profile information about users of the network 106 (e.g., the humans) may include demographic information for each user, personal information for each user (e.g., identity information like name, contact information such as street address, e-mail address, phone number, etc.).

In accordance with embodiments described herein, one or more computerized agents 108A, 108B, 108C (collectively referred to herein as agents 108, or generically as agent 108) may also act as a user of the network 106 and may communicate via the network 106. Each agent 108 may be implemented by an agent facility executing on a computing device, which may be configured for the agent 108 to communicate in a certain manner via the network 106, to assist with achieving a goal. As discussed above, the goal may be a goal related to the humans, such as to cause all or a portion of the humans to act or think in a particular way. The agent facility may, in some embodiments, be autonomous once configured, such that the agent facility determines content of messages to communicate via the network 106 without involvement from a human. In some embodiments, an agent facility may be reconfigured before a goal is met, to aid in achievement of the goal. However, apart from configuration of parameters with which the agent facility operates, the agent facility may autonomously operate in accordance with its configuration to determine content of messages to be transmitted via the network 106 and to communicate those messages via the network 106. Though, in other embodiments, a human user may be able to specify content of one or more messages to be communicated by an agent facility, in addition to (or instead of) the agent facility autonomously selecting content and communicating messages.

Each of the agents 108 may impersonate a human in the network 106, which is illustrated in FIG. 1 through the dotted-outline of a human for each agent 108. In some embodiments, the network 106 may not be informed that the agents 108 are not human and the network facility of the network 106 may treat each of the user that are agents 108 in the same manner as other users that are humans 102. In other embodiments, the network 106 may be informed that the agents 108 are not human, but the network facility may still treat each of the user that are agents 108 in the same manner as other users that are humans 102. In still other embodiments, the network 106 may be informed that the agents 108 are not human, and the network facility may communicate messages between humans 102 and agents 108 and may present to the humans 102 messages sent by agents 108 in the same manner as messages sent by other humans 102, or otherwise publicly treat the agents 108 in the same manner as the humans 102, so as to avoid revealing to the humans 102 that the agents 108 are not human.

System 100 may additionally include a computing device 110 executing a configuration facility to configure each of the agent facilities for agents 108 and/or to configure a network facility of the network 106 for the agents 108 to communicate to the humans 102 in the network to achieve the goal. Examples of the configuration are described above. In some embodiments, for example, the configuration facility may retrieve from the network facility information on an arrangement of the humans 102 in the network 106, which may include information on a number of the humans 102 and an interconnectedness of the humans 102 in the network 106. Based on the information retrieved from the network 106, and/or on the terms of the goal, the configuration facility may determine a manner in which to configure the agents 108, including a manner in which to configure each agent facility. Determining the manner may include selecting values for parameters with which to configure the agent facilities, including differing values for different agents 108. The configuration facility is not limited to a particular manner in which to determine the values for the parameters. For example, in some embodiments the information received from the network 106 and/or information on the goal may be output via a user interface to a human administrator, who may then input the values for the parameters to the configuration facility. As another example, in some embodiments the configuration facility may provide the information on the goal and/or information received from the network 106 to a learning facility, which determines the parameters to be used. In particular, the learning facility may learn over time a particular configuration for one or more of the parameters with which a configuration facility and/or a network facility is to be configured based on information regarding a goal and/or information regarding an arrangement of humans in a network. The learning facility may implement any suitable machine learning technique, as embodiments are not limited in this respect. In some embodiments, the learning facility may be configured to learn configuration parameters that lead to fastest achievement of a goal, while in other embodiments the learning facility may be configured to learn configuration parameters that lead to most widespread achievement of a goal (e.g., highest portion of humans meeting the goal, such as acting or thinking in the intended manner).

In some embodiments, the configuration facility may set parameters with which to configure the agents 108. Examples of these parameters include placement/position of agents 108 in the network 106, a “noisiness” of the agents 108 in the network 106, visibility of the agents 108 to the humans 102 in the network 106, and/or other parameters discussed above.

In some embodiments, the configuration facility may set a position parameter. The position of an agent 108 in the network 106 may be indicative of a degree of interconnectedness of the agent 108 in the network, to other agents and/or to humans of the network. For example, an agent in a “central” position in the network may be densely interconnected with other agents and/or humans in the network (i.e., have a larger number/higher degree of neighboring connections) while an agent in a peripheral position in the network may be sparsely interconnected with other agents and/or humans in the network (i.e., have a lower number/lower degree of neighboring connections). In some instances, the position of the agent may include a geodesic location of the agent in the network, e.g., central or peripheral location, even if the agent has a same number of connections in both locations. In other instances, the position of the agent may include a random location/position assigned to the agent in the network. When setting the position parameter, the configuration facility may select a value indicative of a central, peripheral, or random position/location for the agent. Such a value may in some embodiments indicate a number of interconnections each computer agent should have, or may indicate one or more ranges for numbers of interconnections of each computer agent.

In some embodiments, the configuration facility may select a value associated with a noisiness parameter. The level of noisiness associated with each agent 108 in the network 106 may impact actions taken by a computerized agent at any given time. “Noisiness” may be understood for some embodiments to be similar to “noise” in a “signal to noise” context. In the “signal to noise” context, the “noise” in a received signal is extraneous content in the received signal, that is apart from the real “signal” that is included in that received signal. Similarly, “noisiness” in some embodiments may refer to a share of actions taken by the computerized agent, including communications with other agents or humans in the network, that do not facially appear directed to influencing the humans toward a goal. In such a case, if the actions of the agent that are facially influencing humans toward the goal are the “signal,” the other actions (that do not facially appear to be influencing the humans toward the goal) would be the “noise.”

The inventors recognized and appreciated that adjusting the behavior of agents such that they occasionally act in a manner that appears to contravene the goal, such as by appearing to influence the humans away from performance of the goal, or that does not appear to influence the humans toward the goal, may actually increase an overall likelihood that the humans will be influenced to act in a certain way and the goal will be achieved or the humans will be closer to achieving the goal. For example, as explained above, in some embodiments, an agent may be configured to act in a manner that temporarily hinders the performance of the goal at the time, or that appears to influence humans away from the goal or achieving the goal. Such actions may vary, based on the nature of the network and of the goal.

For example, in some embodiments, the agent may be configured to influence the humans toward the goal by selecting how to act at the times by determining, based on information about the network, humans, or goals (e.g., a state of one or more humans, or recent actions by the humans, or how close the humans are to the goal, or other information), what action the agent can take that is most likely to influence the humans toward the goal or that may have the largest influence of encouraging humans to achieve the goal. The agent may do this by selecting one of a limited set of actions the agent may take, based on the information regarding the network, humans, and/or goals. For example, the agent may generate for each action and based on the information a probability estimate that indicates a likelihood that the action will successfully influence the humans toward the goal. At times that the agent is to act in a manner that has a high likelihood, at the time, of influencing the humans toward the goal, the agent may select the action(s) that have a high likelihood and perform those actions. At other times, however, the agent may seek to hinder the humans from achieving the goal, as discussed above. At such a time, the agent may calculate similar probabilities and select an action, from the set of actions, that has a lowest likelihood of encouraging humans toward the goal or that has a highest likelihood that the action will not influence the humans toward the goal.

As another example of actions that an agent may take that may not directly influence the humans toward achieving the goal, in some embodiments an agent may be configured to perform, at a time, one of a limited set of actions, as in the example directly above. At some times, though, rather than selecting an action based on whether the action will or will not influence the humans toward the goal at that time, the agent may randomly select an action and perform the action, without reference to whether the selected action will contribute to a desired outcome of achieving the goal.

Actions that an agent may take at a time may include communicating messages to one or more other agents or humans in the network. An agent may be configured to select content of the message at a time, including in accordance with the “noisiness” factor. For example, when the agent is configured to communicate information (e.g., by communicating messages in the network) to assist with achieving the goal of spreading correct information to a group of humans in the network, the agent may be further configured with a certain level of noisiness where the agent may at a time communicate erroneous information or randomly select whether to communicate correct information or erroneous information, or at times communicate information irrelevant to accomplishing the goal, thereby temporarily deviating from the performance of the goal.

Accordingly, the agents may occasionally act in a manner that does not appear to be influencing humans toward the goal, but is indirectly influencing the humans toward the goal, while at other times the agents may act in a manner that directly influences the humans toward the goal. Such indirect influencing may include hindering achievement of the goal at a time, or acting at a time without regard to whether an action will directly assist or not assist the humans with the goal.

Accordingly, in some implementations, the configuration facility may select a value comprising a probability that affects how each agent 108 acts at a time to influence the humans towards accomplishing the goal, wherein the probability affects how the agent acts by impacting whether the agent at the time directly assists with performance of the goal at the time or at the time indirectly assists with the performance of the goal at the time. For example, each agent may be configured with a probability to be used by the agent in selecting content of a message to be communicated at a time, such that content that assists with performance of the goal may be communicated at a time with the configured probability, and content that indirectly assists with the performance of the goal with a complementary probability. As another example, each agent may be configured with a probability such that content that assists with performance of the goal may be communicated at a time with the configured probability, and content that indirectly assists with the performance of the goal may be communicated with a second probability.

In some embodiments, the configuration facility may set a visibility parameter, where the visibility parameter associated with each agent 108 in the network 106 may be indicative of whether the agent in the network is identified to the humans 102 in the network as a computerized agent, such that the humans are aware that the agent is not a human. If the computerized agent is set not to be visible, then the computerized agent may assume a persona (as discussed above) as if the computerized agent were a human, or may not expressly indicate to humans that the agent is nonhuman. When selecting a value associated with the visibility parameter, the configuration facility may select a value indicative of the revealed status for the agent.

Once the configuration facility determines the configuration to be made to the agents 108, including (for example) values for parameters, the configuration facility configures the agents 108 to communicate in the network to achieve the goal. The configuration may include configuring agent facilities with values for parameters and may further include configuring the network facility, such as by registering new agents 108 as users of the network 106, de-registering previously-registered agents 108 that are no longer to be users, changing profile information for agents 108, changing an interconnectedness of the agents 108 with other agents and/or with the humans 102, and/or changing the position, level of noisiness, and/or visibility of the agents 108 in the network 106. Changing the interconnectedness of an agent 108 may include creating or removing associations in the network 106 between the agent 108 and one or more agents 108 or one or more humans 102. Changing the position of an agent 108 may include changing a degree of interconnectedness of the agent 108 or a geodesic location of the agent 108 in the network. Changing the level of noisiness of an agent 108 may include changing a probability that affects how the agent acts at a time to either directly or indirectly assist with performance of the goal. Changing the visibility of an agent 108 may include changing the revealed status of the agent. While, for ease of illustration and discussion, FIG. 1 illustrates separate elements (e.g., computing devices) for the agent facilities, the network facility, the configuration facility, and the learning facility, it should be appreciated that embodiments are not limited to executing these facilities on different devices. Two or more, or all, of the facilities may be executed on a same device. For example, in some embodiment, all of the agent facilities, the configuration facility, and the learning facility may be executed on a same computing device or set of computing devices as the network facility. In some such embodiments, the agent facilities, configuration facility, and learning facility may be operated by a same entity as the network facility, such that the agents are operated by a same entity as the network. In other embodiments, however, the agents may be operated by a different entity than the network.

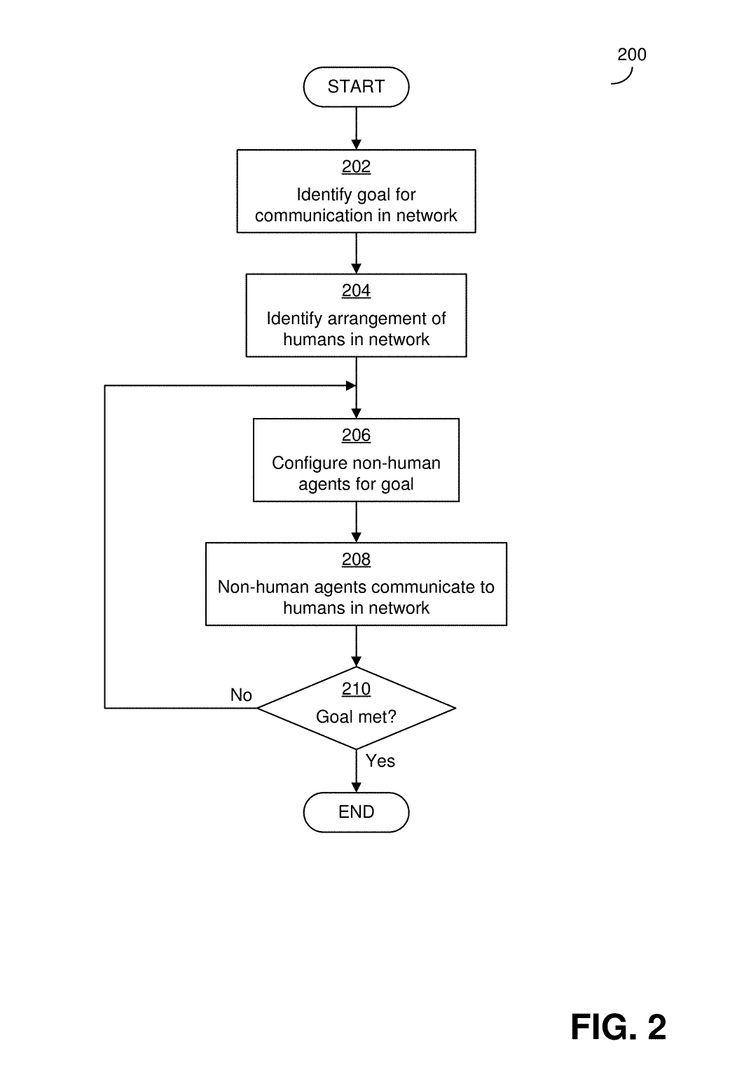

FIG. 2 illustrates an example process 200 that may be implemented in some embodiments to enable agents to communicate in a network to influence humans toward achievement of a goal. Prior to the start of the process 200, humans may be registered with a social network and each human may be connected to one or more other humans in the social network, such that a social network stores information on each of the humans and information on an interconnectedness of the humans.

The process 200 begins in block 200, in which a configuration facility receives a specification of a goal for communication in a network. The specification of a goal may include terms of a goal. The terms may include, for example, a number of humans to be influenced for the goal to be identified as achieved, which may be an absolute number of humans or a portion or all of the humans in the social network. The portion of the humans may be specified in any suitable manner, such as by identifying a percentage or fraction of the humans and/or a particular characteristic (e.g., a demographic characteristic, an interest or hobby, etc.) specified by the humans in profile information and/or messages communicated by the humans in the social network. The terms of the goal may also include the nature of the goal, such as whether the goal is to influence actions of the humans or to influence opinions or knowledge of the humans. The terms of the goal may also include a timeframe for achieving the goal, such as a length of time or a deadline by which the goal should be achieved for the goal to be successful.

In some cases, the humans may be aware of the goal and share the goal. For example, in some cases, the network may be related to the goal, such as in the case that a goal relates to an individual health of the humans and the humans join the network for the purpose of achieving that goal (e.g., a network that specifically relates to weight loss or quitting smoking). In other cases, however, the humans may not be aware of the goal. For example, if the goal relates to quickly distributing correct information regarding a public emergency, such that members of the public understand the facts surrounding the emergency as quickly as possible, the humans may not yet be aware of the emergency when the agents are configured and thus may also not be aware of the agents' goal.

In block 204, the configuration facility identifies an arrangement of humans in the network. As discussed above, the arrangement of the humans may include information on a number of the humans in the network and an interconnectedness of the humans in the network. The interconnectedness of the humans may include, for each human, an identification of how the human is connected to other humans or a number of other humans to which the human is connected, or a topology of the connections between the humans in the network.

Based on the specification of the goal and the information on the arrangement of humans in the network, in block 206 the configuration facility configures one or more non-human agents to communicate in the network to influence humans toward achieving the goal. The configuration may involve configuring the agents and/or configuring the network. For example, the configuration facility may configure the network by adding or removing agents as users of the network and/or by creating or removing connections of the agents to humans of the network. In some embodiments, when the configuration facility configures the network to add or remove connections between agents and humans in the network, the connections may be added or removed with or without the knowledge or approval of the humans. In the case that only a portion of the humans of the network are to be evaluated in considering whether a goal is met (e.g., only humans having a particular characteristic), the humans to which the agents are connected may include humans that are to be evaluated and may include other humans that are not to be evaluated (e.g., humans not having the particular characteristic). With respect to agents, the configuration facility may configure agent facility with particular parameters such as delays to be used in communicating messages, probabilities to be evaluated in determining content of messages, position of agents in the network, visibility of the agents, or other parameters that may influence behavior of the agents with respect to communications in the network.

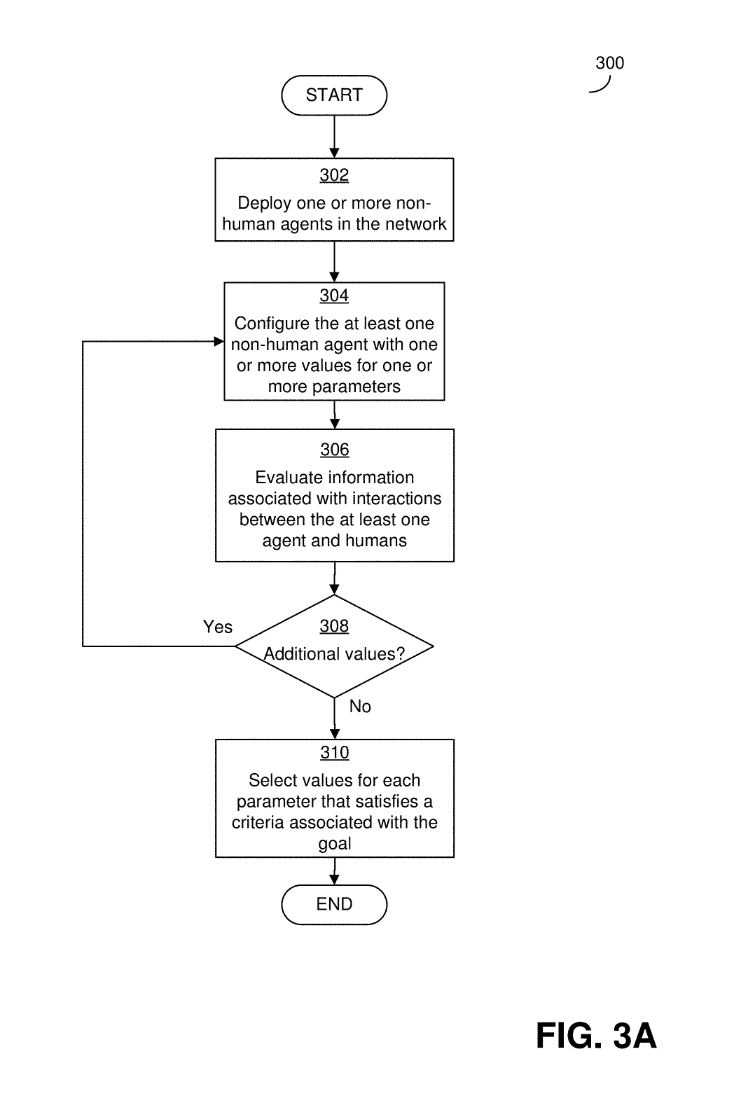

In some embodiments, the configuration facility may provide the information on the goal and/or information received from the network 106 to a learning facility, which determines the values for the parameters (e.g., number of agents, position of agents, level of noisiness of agents, visibility of agents, and/or other parameters) to be used. In particular, the learning facility may learn over time a particular configuration for one or more of the parameters with which a configuration facility and/or a network facility is to be configured based on information regarding a goal and/or information regarding an arrangement of humans in a network. FIGS. 3A-3B illustrate example processes 300, 350 that may be implemented by the learning facility during a learning phase in some embodiments to select values for the parameters to be used to configure the agents 108. It should be appreciated, however, that the examples of FIGS. 3A-3B are merely illustrative and that other processes may be used.

Referring to FIG. 3A, the process 300 begins in block 302, where one or more non-human agents 108 may be deployed to interact with the humans 102 in the network. In block 304, the learning facility may configure each agent with one or more values (e.g., first values) associated with one or more parameters. In block 306, the learning facility may evaluate information associated with interactions between the agents and the humans. Such information may include a manner in which the humans are interacting with one another and with the agents, or how the humans are progressing toward the goal. Such information may indicate, over time, how the humans are responding to the agents. In block 308, a determination is made regarding whether the agents are to be configured with additional values. For example, if the evaluation of block 306 indicates that the humans are not progressing toward the goal, or a regressing away from achieving the goal, then the values may be changed over time, to set different values for one or more of the parameters. As a further example, if the evaluation of block 306 indicates that the humans have decreased interacting in the network, it may be that the humans are not responding well to the network with the inclusion of the agents and that fewer agents may be needed or the agents may need to communicate less.

In response to a determination that the agents are to be configured with additional values, the process 300 returns to block 304, where each agent may be configured with additional and/or different values (e.g., second values) associated with the one or more parameters. A variety of machine learning processes may be used to set values in block 304 responsive to evaluation of block 306 and the determination of block 308. In some embodiments, for example, a genetic algorithm may be used to select parameters to be adjusted and values to set for those parameters. Embodiments are not limited to operating with any particular form of learning or adjustment.

The process repeats block 306 where the learning facility may evaluate information associated with subsequent interactions between the agents and the humans. In other words, the learning facility may adjust values for various parameters and evaluate corresponding interactions (i.e. repeat blocks 304 and 306) it is determined that the parameters are not to be altered further.

If, however, the learning facility determines in block 308 that the parameters are not to be altered further, the learning facility may, in block 310 and based on the evaluations performed for the different values, asset the value for each parameter that satisfies a criteria associated with the goal. For example, in some embodiments, the learning facility may select values for the parameters that lead to fastest achievement of a goal, while in other embodiments the learning facility may select values for parameters that increased the likelihood of the goal being achieved. For example, when the learning facility determines that configuring the agents with a first value increased the likelihood of the goal being achieved in comparison to configuring the agents with the second value, the learning facility may select the first value for the parameter.

Referring to FIG. 3B, the process 300 begins in block 352, where the learning facility may evaluate information associated with interactions of humans 102 in the network 106 without any non-human agents 108 being deployed in the network. In block 354, the learning facility may simulate the network by deploying one or more agents 108 and configuring the agents 108 with a plurality of values associated with each of the one or more parameters. In block 356, the learning facility may select, based on the simulation, one of the values for each parameter with which to configure the agents.

Referring back to FIG. 2, in block 206 the configuration facility, in some embodiments, may configure the non-human agents 108 to communicate in the network 106 to influence humans toward achieving the goal based on the values selected by the learning facility.

In block 208, once the agents are configured, the agents are operated to communicate in the network to the humans. The agents may operate autonomously via agent facilities, such that the agents may receive and evaluate messages from the humans and/or other agents, and determine content to be included in a message and transmit messages to humans and/or other agents, without input from a human in the network or a human administrator of the agents or network.

In block 210, the configuration facility may determine whether the goal is met, including whether progress has been made toward achieving the goal. The facility may determine whether the goal has been met by evaluating information communicated by the humans in the network, or other information regarding activities of the humans that may be available outside the social network. The goal may influence the type of information that is evaluated by the configuration facility to determine whether the goal is met. For example, if the goal relates to influencing opinions or knowledge of the humans, the facility may determine whether the goal is met by evaluating content of messages sent by the humans, to determine whether the messages include content expressing the desired opinion or information. If the goal relates to actions to be taken by the humans outside the social network, then in some cases messages sent by the humans via the social network may be evaluated for information indicative of performance of the activity (e.g., messages stating the human performed the activity, or a location “check-in” in the social network identifying that the human was at a location at which the activity is performed) or information available outside the social network may be retrieved. For example, if the goal relates to habits that may be expressed through purchasing behaviors (e.g., whether a human has quit smoking may be evaluated by whether the human purchased tobacco products or purchased fewer tobacco products in a time period than previous), information on purchasing behaviors from financial accounts, store loyalty programs, etc. may be retrieved. If the goal relates to attendance at a program (e.g., a weight loss program, an addiction treatment program, a charitable activity, etc.), then attendance records for the program may be retrieved and evaluated. Any suitable information may retrieved and evaluated in block 210, as embodiments may operate with diverse types of goals.

If the facility determines that the goal has been met, then the process 200 ends.

If, however, the configuration facility determines in block 210 that the goal has not been met, then the process 200 returns to block 206. In block 206, the configuration facility configures the agents for performance of the goal. The configuration of block 206 following the determination of block 210 may include changing a configuration. This may be the case where acceptable progress has been made toward achieving the goal and some changes to the configuration may be made to ensure that progress continues to be made, such as by slowing or speeding the rate of the progress. For example, it may be the case that as the humans are influenced toward progress of a particular goal or type of goal, the agents may influence the humans less as the humans may be more likely to continue progress toward the goal by influencing one another rather than being influenced by the agents. As another example of changing the configuration, if the configuration facility determines that unacceptable progress or no progress has been made toward achieving the goal, changes may be made to the configuration to speed the rate of progress. The change to the configuration may include adjusting one or more parameters, such as a number of agents, a number of humans to which one or more agents are connected, a delay or probability used by one or more agents, or other parameters. As discussed above, the parameter to be used may be set based on input from an administrator of the configuration facility and the agents or an administrator of the network, or may be set using a learning facility that operates a suitable machine learning process.

In some embodiments, the agents themselves may be configured to learn from prior interactions with the humans in the network and accordingly change their configuration, for example, by adjusting the one or more parameters.

Techniques operating according to the principles described herein might help to address diverse problems, including complex coordination problems in which a varied group of humans coordinate with one another to achieve some common goal. For example, crowd-sourcing applications in science (such as solving quantum problems or other types of scientific research ranging from protein folding to the assessment of archaeological or astronomical images) might be facilitated by adding some computerized agents to groups of humans working collaboratively and manipulating various parameters of the computerized agents to assist the humans in achieving a collaborative or collective goal (e.g., locating a particular landmark from a number of archaeological images).

Provided below is an example coordination scenario, where techniques operating according to the principles described herein may be used. In particular, details regarding a number of experiments involving a networked color coordination game in which groups of humans interacted with autonomous computerized agents are provided herein. Further details regarding this example coordination scenario and the involved experiments may be found in the article titled “Locally noisy autonomous agents improve global human coordination in network experiments,” by Hirokazu Shirado and Nicholas A. Christakis in Nature International journal of science, Vol. 545, pgs. 370-374 (18 May 2017), which article is incorporated by reference in the present application in its entirety and at least for its discussion of techniques for configuring computerized agents to interact with networks of humans. (It should be appreciated that, if any terminology is used in the incorporated article in a manner that conflicts with the usage of the terminology herein, such terminology should be understood in a manner most consistent with its usage herein.)

In the networked color coordination game, humans were placed in a social network and given a visual representation of their local network (i.e., they could see their immediate neighbors). The visual representation of themselves and their neighbors bears a color on the computer screen, and the goal is for no two neighbors to have the same color. Players could alter their node color in response to their neighbors, attempting to reach a collective goal in which every player's color is different from all their neighbors.

A number of humans subjects were embedded in networks of twenty (20) nodes to which three (3) computerized agents were added. The computerized agents were configured with various levels of noisiness and different positions to determine what particular configuration improved the collective performance of the human groups in the network (e.g., accelerating median solution time for reaching the goal in which every player's color is different from all their neighbors).

A number of human subjects (e.g., 4000 subjects) were randomly assigned to 1 of 11 conditions in a series of 230 sessions. The subjects were assigned a location in a network of 20 nodes and the network structure was created de novo for each session by attaching new nodes (each with two links) to existing nodes; and subjects were placed into the resulting networks at random. As mentioned above, the collective goal to be achieved was for every node to have a color different than all of its neighbor nodes.

In the sessions, each subject was allowed to choose a color from three choices (green, orange, and purple) at any time. The number of colors made available was the minimum necessary to color the entire network without conflicts, which is known as the “chromatic number”; and all networks in the experiments were, by construction, globally solvable. Subjects could see only the colors of neighbors to whom they were connected, in addition to their own color. Thus, although a particular human subject might have solved the problem from his or her own point of view, the game might continue because the network still had conflicts in other regions of the graph.

With this basic setup, three computerized agents were deployed/introduced into the network in exchange for the same number of human subjects. The subjects were not informed that there were computerized agents in the network. The level of noisiness of the computerized agents was manipulated as follows. In the “zero noise” condition, the computerized agents behaved with a simple, greedy strategy: when an agent had a chance to minimize color conflicts with its neighbors, it chose that color; otherwise, it maintained its current color. In the other two conditions, the agents behaved with the same greedy strategy most of the time, but they also randomly picked a color from the three permissible options regardless of their local situation—with a probability of 10% (“small noise”) or 30% (“large noise”). In all the conditions, the agents made decisions every 1.5 seconds, which was the typical human reaction time.

Independent of level of noisiness, the position of the computerized agents was also manipulated as follows. In the “central” condition, the agents were assigned to the three positions that had the largest number of neighbors (the highest network degree). Likewise, in the “peripheral” condition, the agents were assigned to the three positions with the lowest degree. In the “random” condition, the agents were randomly assigned to their locations. It was permissible for the agents to be connected to each other, by chance, in all conditions.

As noted, the agents acted using only their local information. To assess the effect of such behavior compared to the much more demanding case requiring global knowledge of the entire network structure and its solution space in advance, experiments were carried out with a “fixed color” condition. In this extra condition, all color combinations of each network that resulted in no conflicts were evaluated, and then the initial colors of three of the nodes were assigned based on one of those combinations (chosen at random). That is, during the game, the three nodes were not controlled by the agents that coordinated with their neighbors, but rather, these nodes simply stayed at their initial colors, which were known to be consistent with a global solution to the problem. This treatment was evaluated in the case in which the fixed nodes were in the central position.

In summary, 11 conditions were evaluated: 1 control condition not involving any computerized agents; 9 treatment combinations of noisiness and position of the agents (i.e., 3 levels of noisiness (0%, 10% and 30%) crossed with 3 types of positions (random, central, and peripheral), and 1 final condition with 3 fixed-color nodes. Thirty (30) sessions were conducted for the first condition and twenty (20) sessions for each of the treatment combinations for a total of 230 sessions with 4000 humans.

For the games involving only humans, 20 of 30 resulted in an optimal coloring of the network in less than the allotted 5 minutes (median time=232.4 seconds; interquartile range (IQR) 143.7-300.0). Although the humans aimed to eliminate all the conflicts, they often found themselves unable to reach the collective goal only by reducing their local conflicts on an individual basis. For example, it was observed that at a certain time (e.g., 105 seconds into the game), each of the humans had chosen one of the least common colors among their neighbors; that is, no one person could change their color for the better. A conflict between neighbors, however, still remained. Such states in which players get caught in locally unresolvable conflicts are regarded as local minima of the game's cost function (in contrast to resolvable conflicts which can be addressed by local action).

By analyzing the sessions involving only humans, it was determined that games were more likely to be solved when some players occasionally chose a locally inappropriate color, temporarily increasing conflicts; moreover, the effect of such behavioral deviance varied according to the geodesic location of the players, as captured by their network degree.

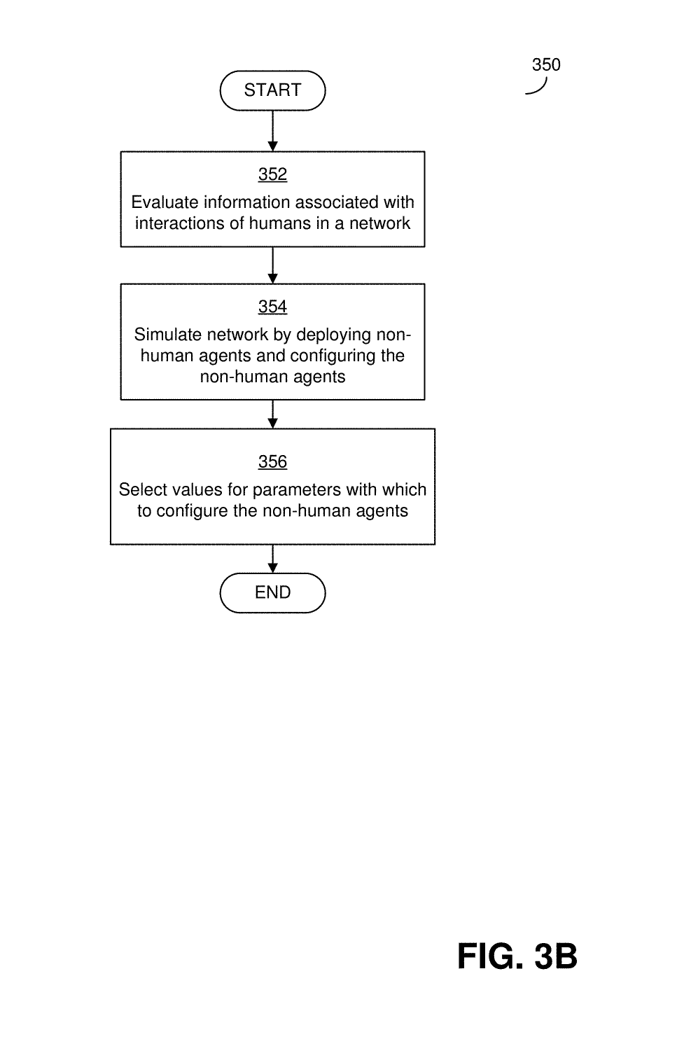

To demonstrate how computerized agents could improve the performance of human groups, FIG. 4 shows survival curves of the sessions involving the 9 treatment combinations. The curves show the percentage of sessions unsolved at a given time. The darker colored curves show results for sessions including computerized agents, by their level of noisiness (horizontal dimension) and position (vertical dimension). The lighter colored curves show results for sessions involving solely humans. Before implementing pairwise comparisons of each group (involving the treatment combinations) with the group involving only humans (i.e., control group), a log-rank test was performed of the null hypothesis that all the survival curves are identical; that hypothesis was rejected (P=0.024), indicating that at least two of the survival curves differed. Sessions were censored at 300 s and P values in FIG. 4 represent the log-rank test.

It was demonstrated that sessions having computerized agents with 10%-noise and central positions, as shown in box 410 of FIG. 4, were the most likely to be solved within the allotted 5 minutes (17 of 20 sessions, or 85%, compared with 20 of the 30 control sessions, or 67%, with humans alone); moreover, the solution was achieved more than 129.3 seconds faster (i.e., 55.6% faster) than sessions involving just humans (median time=103.1 seconds (IQR 49.5 170.1) versus 232.4 seconds (IQR 143.7-300.0)), which was significantly better (P=0.015, log-rank test).

It was observed that the impact of 10%-noise agents was comparable to the impact of assigning three nodes with fixed (constant) colors in a configuration known ex ante to be compatible with a global solution. There was no significant difference between the sessions with 10%-noise agents and the sessions with fixed colors (P=0.675, log-rank test). Thus, the intervention of the computerized agents, based on local decision-making alone, is equally as effective as a pre-calculated solution that (in typical circumstances) impractically would require prior global knowledge of the entire network structure and its solution space.

The computerized agents improved collective performance in part by changing the color-conflict behaviors of humans in the whole system. When placed at high-degree nodes, the agents with 0%-noise reduced the number of conflicts but increased the duration of unresolvable conflicts; the agents with 30%-noise decreased the duration of unresolvable conflicts but increased overall conflicts; and only the agents with 10%-noise decreased both the number of conflicts and the duration of unresolvable conflicts, compared with sessions involving solely humans.

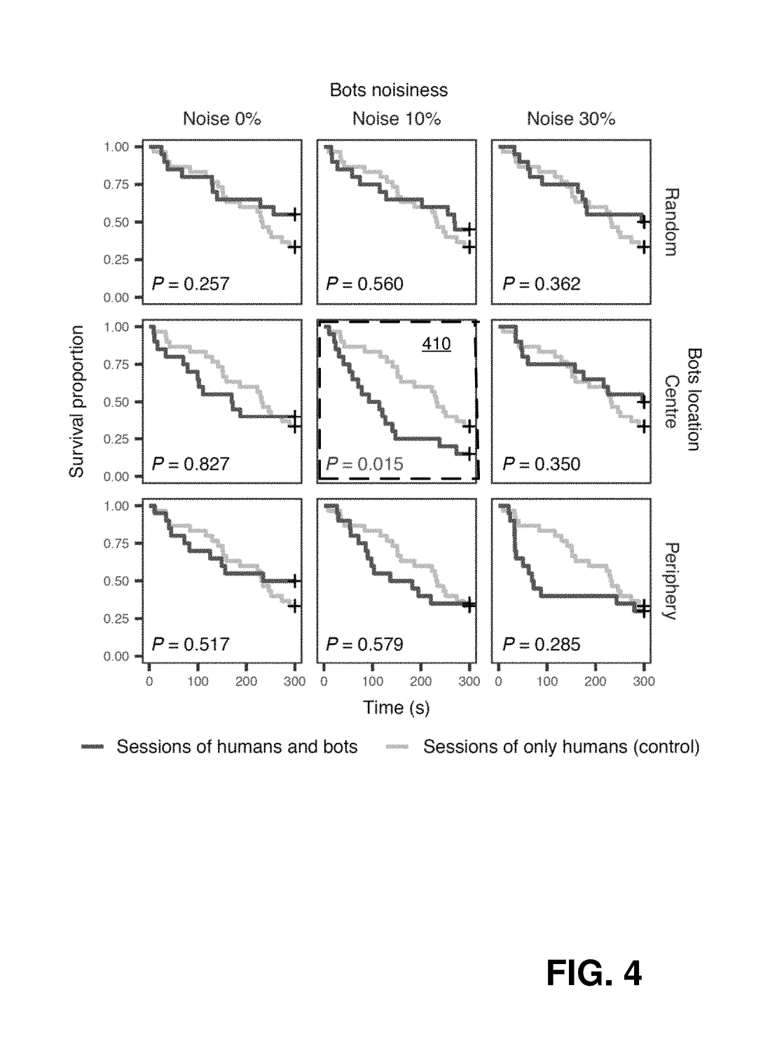

When the computerized agents were placed in high-degree positions, their noisiness was able not only to facilitate the solution of their own conflicts, but also to nudge neighboring humans to change their behavior in ways that appear to have further facilitated a global solution. The agents with 0%-noise reduced the randomness of other human players, which made the human players, particularly the middle-degree players, come to be stuck in unresolvable conflicts. The agents with 30%-noise destabilized the entire network, including the low-degree players, who displayed more noise in their own actions; as a result, the sessions with 30%-noise agents showed the same level of unresolvable conflicts as those without agents. The agents with 10%-noise increased the randomness of the central players but reduced that of the peripheral players; hence, through the influence of their noisiness, the 10%-noise agents reduced the unresolvable conflicts not only of themselves but also of the entire network, including links between human subjects unconnected to the agents. The graphs (d)-(f) depicted in FIG. 5 show the average accumulated time of unresolvable conflicts per link for each position (e.g., geodesic location) of the players. The darker colored lines show results for sessions with central agents (whose degree was typically greater than or equal to 6), by their noise level, and the lighter colored lines show results for sessions involving only humans. As can be seen in graph (e), agents with 10%-noise change the behaviors of the human players in the whole system for the better.

In a separate, further experiment involving an additional 340 humans and a matched set of n=20 graphs, it was demonstrated that these beneficial effects on group coordination and learning were obtained even when human players knew they were interacting with computerized agents (i.e., the computerized agents were identified/revealed as agents to the humans).

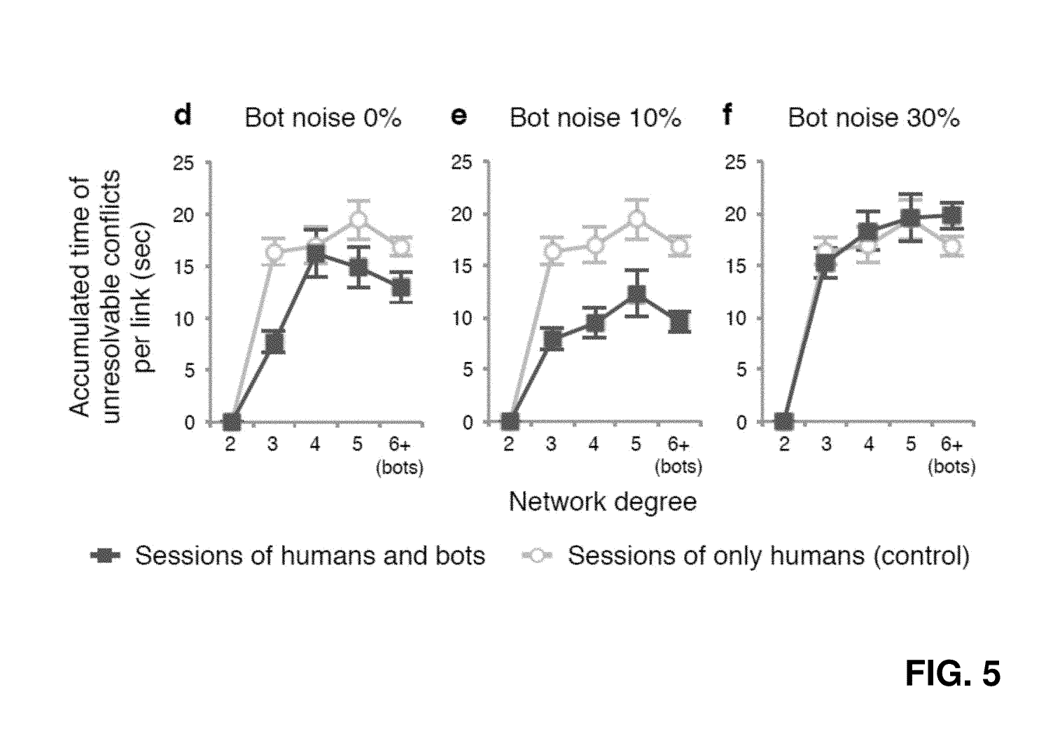

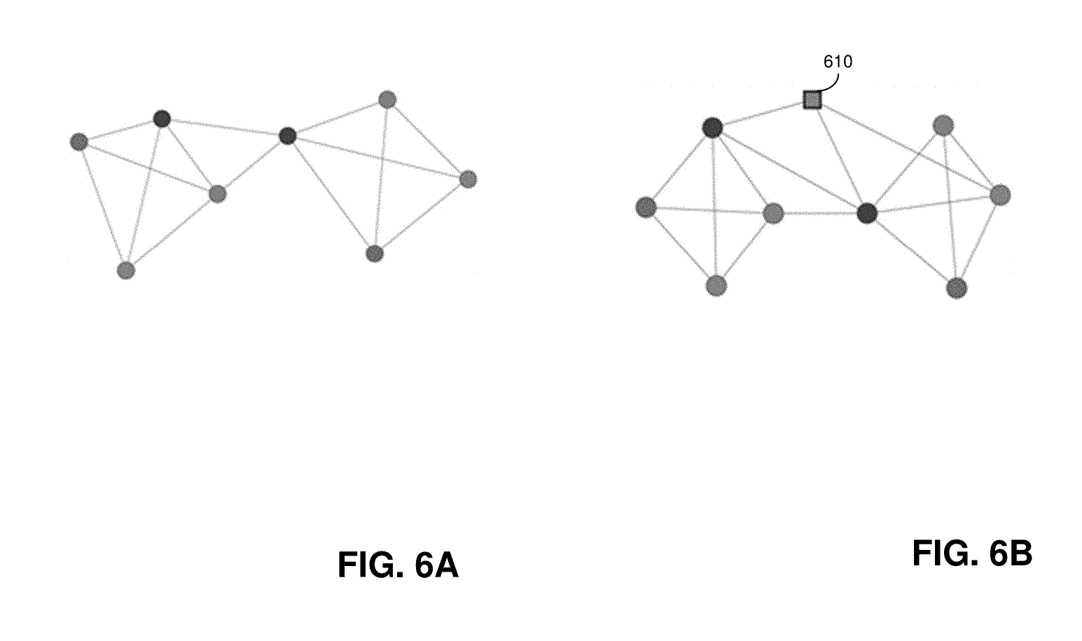

In addition, it was observed that human groups attempting to solve the color coordination problem/game in control sessions got trapped in a suboptimal configuration when the network was composed of social clusters, where ties are dense within and sparse between the clusters, as shown in FIG. 6A, for example. Placing agents (e.g., agent 610) to widen the bridge connecting the clusters, as shown in FIG. 6B, can at least temporarily increase the rate of local conflict in the cluster but improve the overall collective performance.

In summary, it was demonstrated that: 1) moderate level of noisiness in agent behavior raises the overall success rate of coordination the most, compared with low and high level of noisiness, and decreases the time to reach a global solution; 2) agents placed in central positions (i.e., center of the network) raise the success rate of coordination, and decrease the time to reach the global solution; 3) identifying the agents to the humans as agents does not affect targeted outcomes; 4) a moderate (but not small or large) quantity of bots placed in the network raises the success rate of coordination, and decreases the time to reach the global solution; and 5) agents configured to build redundant paths along bridges raise the success rate of coordination, and decrease the time to reach the global solution.

Based on the findings above, it was concluded that adding computerized agents with simple strategies into social systems may make it easier for groups of humans to achieve a global goal for complex group-wide tasks. While, the above experiments were performed in connection with a networked coordination game setting, other settings might include cooperation where the goal is to improve the rate of group-level cooperation, sharing where the goal is to reduce human selfish behavior, navigation where the goal is to alleviate traffic congestion, or evacuation where the goal is to raise the rate of successful evacuation in cases of emergency. It was further demonstrated that adding computerized agents with a certain level of noisiness and central position in the network not only made the task of humans to whom they are connected easier, but also affected the gameplay of the humans themselves when they interacted with still other humans in the group, thus creating cascades of benefit. And this holds true even when humans know that they are interacting with agents. In this sense, the agents can serve a teaching function, changing the strategy of their human counterparts and modifying human-human interactions, and not just affecting human-agent interactions.

It will be appreciated that while the experiments mentioned above were performed for a defined group of individuals (i.e., groups with a boundary that did not change during interaction with the agents), the findings may be applicable to a larger groups of individuals as well. In addition, while the techniques described above illustrate the performance of combined, heterogeneous groups composed neither solely of humans nor solely of computerized agents attempting to coordinate their actions, these techniques can be applied and implemented in other types of complex interactions, such as military or commercial robots working within human groups, or autonomous vehicles moving in a world of human-driven cars.

Techniques operating according to the principles described herein may be implemented in any suitable manner. Included in the discussion above are a series of flow charts showing the steps and acts of various processes that use autonomous agents communicating in a network to influence humans toward achieving a goal. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

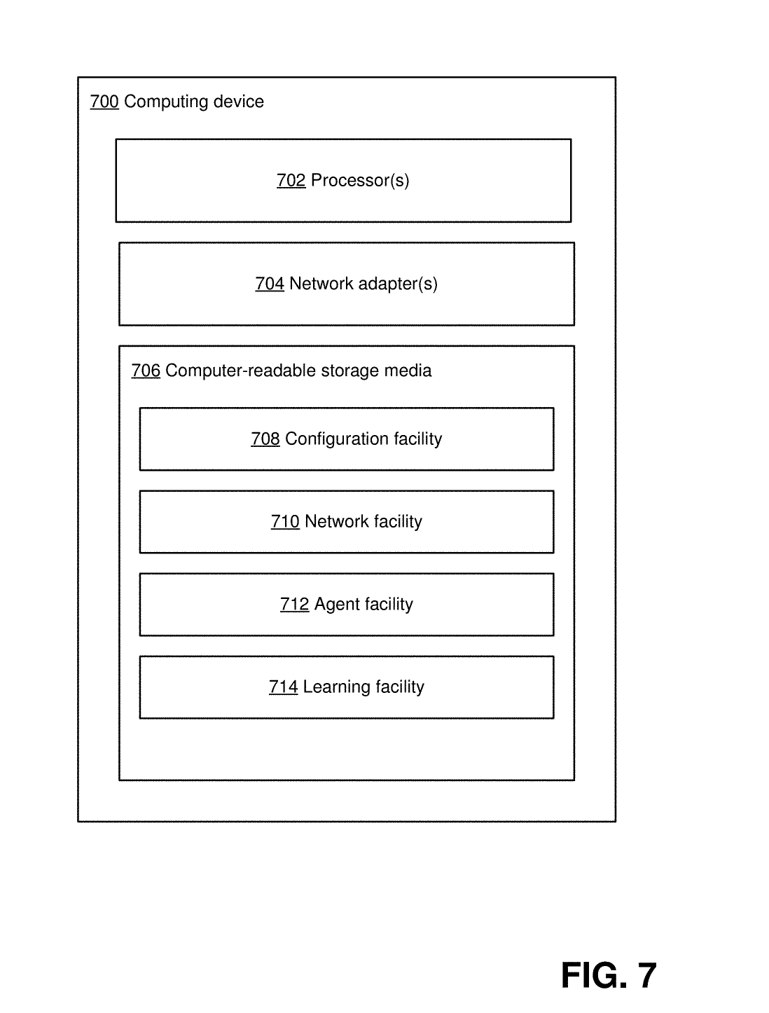

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 706 of FIG. 7 described below (i.e., as a portion of a computing device 700) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 7 illustrates one exemplary implementation of a computing device in the form of a computing device 700 that may be used in a system implementing techniques described herein, although others are possible. It should be appreciated that FIG. 7 is intended neither to be a depiction of necessary components for a computing device to operate in accordance with the principles described herein, nor a comprehensive depiction.

Computing device 700 may comprise at least one processor 702, a network adapter 704, and computer-readable storage media 706. Computing device 700 may be, for example, a desktop or laptop personal computer, a personal digital assistant (PDA), a smart mobile phone, a server, or any other suitable computing device. Network adapter 704 may be any suitable hardware and/or software to enable the computing device 700 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 706 may be adapted to store data to be processed and/or instructions to be executed by processor 702. Processor 702 enables processing of data and execution of instructions. The data and instructions may be stored on the computer-readable storage media 706 and may, for example, enable communication between components of the computing device 700.

The data and instructions stored on computer-readable storage media 706 may comprise computer-executable instructions implementing techniques which operate according to the principles described herein. In the example of FIG. 7, computer-readable storage media 706 stores computer-executable instructions implementing various facilities and storing various information as described above. Computer-readable storage media 706 may store a configuration facility 708, a network facility 710, an agent facility 712, and a learning facility 714, each of which may implement techniques described above.

While not illustrated in FIG. 7, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method of influencing humans who interact in a network towards accomplishing a goal, the method comprising:
configuring at least one computerized agent to interact with the humans in the network, wherein configuring the at least one computerized agent comprises:
selecting a value associated with at least one parameter with which to configure the at least one computerized agent, wherein the value associated with the at least one parameter comprises a probability that affects how the at least one computerized agent acts at a time to influence the humans towards accomplishing the goal, wherein the probability affects how the at least one computerized agent acts by impacting whether the at least one agent at the time directly assists with performance of the goal at the time or at the time indirectly assists with the performance of the goal at the time; and
configuring the at least one computerized agent with the selected value associated with the at least one parameter.

2. The method of claim 1, wherein selecting a value associated with at least one parameter comprises:
during a learning phase:
deploying the at least one computerized agent to interact with the humans in the network;
configuring the at least one computerized agent with a first value associated with the at least one parameter;
evaluating information associated with interactions between the at least one computerized agent configured with the first value and the humans;
configuring the at least one computerized agent with a second value associated with the at least one parameter;
evaluating information associated with subsequent interactions between the at least one computerized agent configured with the second value and the humans; and
selecting the first value or the second value for the at least one parameter based on results of the acts of evaluating.

3. The method of claim 2, wherein selecting the first value or the second value for the at least one parameter based on the evaluations comprises:
determining whether configuring the at least one computerized agent with the first value increased a likelihood of the goal being achieved in comparison to configuring the at least one computerized agent with the second value; and
in response to determining that the first value increased the likelihood, selecting the first value for the at least one parameter with which to configure the at least one computerized agent.

4. The method of claim 1, wherein selecting a value associated with at least one parameter comprises:
during a learning phase:
evaluating information associated with interactions of humans in the network without the at least one computerized agent being deployed in the network;
simulating the network by deploying the at least one computerized agent and configuring the at least one computerized agent with a plurality of values associated with the at least one parameter; and
selecting one of the plurality of values for the at least one parameter based on the simulation.

5. The method of claim 1, wherein configuring the at least one computerized agent further comprises:
selecting a value associated with each of a plurality of parameters with which to configure the at least one computerized agent.

6. The method of claim 5, wherein the plurality of parameters comprises a position of the at least one computerized agent in the network.

7. The method of claim 6, wherein the value associated with the position of the at least computerized agent is indicative of a degree of interconnectedness of the at least one computerized agent in the network.

8. The method of claim 5, wherein the plurality of parameters comprises a parameter indicating whether the at least one computerized agent in the network is identified as a computerized agent to the humans in the network.

9. The method of claim 1, further comprising:
evaluating information associated with interactions between the at least one computerized agent and the humans to determine whether the goal has been achieved;
in response to a determination that the goal has not been achieved, re-configuring the at least one computerized agent by setting a different value for the at least one parameter.

10. The method of claim 1, further comprising:
selecting a number of computerized agents to be deployed in the network.

11. The method of claim 1, wherein indirectly assisting with the performance of the goal at the time comprises temporarily hindering the performance of the goal at the time.

12. The method of claim 1, wherein indirectly assisting with the performance of the goal at the time comprises acting randomly at the time.

13. The method of claim 1, wherein the probability affects how the at least one computerized agent acts by selecting content of a message to be communicated to the humans in the network, wherein the content either assists or indirectly assists with the performance of the goal.

14. A system comprising:
a computer-readable medium storing executable instructions; and
at least one processor programmed by the executable instructions to:
configure at least one computerized agent to interact with humans in a network, wherein configuring the at least one computerized agent comprises:
selecting a value associated with at least one parameter with which to configure the at least one computerized agent, wherein the value associated with the at least one parameter comprises a probability with which the at least one computerized agent acts to either assist with performance of a goal or hinder the performance of the goal, while influencing the humans towards accomplishing the goal; and
configuring the at least one computerized agent with the selected value associated with the at least one parameter.

15. The system of claim 14, wherein configuring the at least one computerized agent further comprises:
selecting a value associated with each of a plurality of parameters with which to configure the at least one computerized agent.

16. The system of claim 15, wherein the plurality of parameters comprises a position of the at least one computerized agent in the network, and the value associated with the position of the at least computerized agent is indicative of a degree of interconnectedness of the at least one computerized agent in the network.

17. The system of claim 15, wherein the plurality of parameters comprises a parameter indicating whether the at least one computerized agent in the network is identified as a computerized agent to the humans in the network.

18. A computerized agent configured to interact with humans in a network and influence the humans towards accomplishing a goal, the computerized agent comprising:
at least one processor; and
at least one computer-readable storage medium having encoded thereon executable instructions that, when executed by the at least one processor, cause the at least one processor to carry out a method comprising:
influencing the humans toward accomplishing the goal, wherein influencing the humans comprises interacting with one or more of the humans and wherein interacting with the one or more humans comprises determining a manner in which to interact with the one or more humans, wherein determining a manner in which to interact at a time comprises selecting, based on a parameter, whether to directly assist at the time with performance of the goal or to indirectly assist at the time the performance of the goal.

19. The computerized agent of claim 18, wherein the computerized agent is configured to interact with the humans in accordance with a value associated with each of a plurality of parameters with which the computerized agent is configured.

20. The computerized agent of claim 18, wherein the plurality of parameters comprises a position of the at least one computerized agent in the network.
